(19) United States
(12) Patent Application Publication
(10) Pub. No.: US 2011/0199890 A1
(43) Pub. Date: Aug. 18, 2011

(54) BROADBAND DATA AND VOICE COMMUNICATIONS OVER WIRELESS AND POWERLINE HYBRID NETWORKS

(75) Inventors: Nachum Sadan, Carlisle, MA (US); Rajiv Salimath, Somerville, MA (US); Norm Strandberg, Westford, MA (US); Jeff Vandegrift, Acton, MA (US); John Krumenacker, Allentown, PA (US)

(73) Assignee: AMPERION INC, Lowell, MA (US)

(21) Appl. No.: 12/594,267

(22) PCT Filed: Apr. 2, 2007
(86) PCT No.: PCT/US07/65752

§ 371 Date: Dec. 7, 2010

(51) Int. Cl. H04B 7/14

(52) U.S. Cl. 370/216; 370/315; 370/279

(57) ABSTRACT

The present invention provides hybrid access network architecture to provide broadband data, voice and video services over Internet Protocol. The hybrid access network comprises a wireless distribution system which has wireless mesh network nodes acting as wireless repeaters. Each of these wireless repeaters comprises of at least 3 wireless radios. The hybrid access network comprises of plurality of Broadband over Power Line (BPL) nodes, each node consisting of 2 modems and 4 wireless radios. Each of the BPL nodes acts as a repeater. The hybrid access network terminates the wireless traffic with fewer hops and has a very fast low latency BPL backbone of 1-3 milliseconds latency.

### FIELD OF THE INVENTION

The present invention relates to broadband communications over medium voltage electrical power lines, also known as BPL (Broadband over Power Line). More particularly, the invention relates to BPL in combination with wireless mesh networks.

### BACKGROUND AND PRIOR ART

In general, dependency on network communications has increased many folds in the past decade. Businesses are more and more dependent on network communications as are consumers for voice based communication or for using the internet. The dependency has increased to such an extent that today many people choose to work from home and access their computers in offices remotely. At the same time, people use the same network to communicate over the phone with their friends or colleagues (using VoIP). Convergence in networking (meaning carrying data, voice and video on a single network) and high dependency on network communications for multiple functions means that today networks should be able to deliver very high network reliability and availability. Network reliability relates to delivering data, voice and video packets reliably to the intended recipients and network availability relates to the proportion of expected value of uptime over the total expected value of the uptime and the downtime.

The global IP network can be divided into three major parts: (a) the core of the network which encompasses the public internet, (b) the end users who use CPE—Customer Premises Equipment, and (c) the access network that connects between the end user CPE and the core network (FIG. 1). There are a number of different last mile access technologies that connect CPE users to the core IP network. Among the most common technologies are: cable, DSL, fiber, satellite, and wireless.

A pure wireless mesh network that delivers VOIP over wireless is limited to 3 hops due to internal processing latency delays of 10 to 30 milliseconds or more. Toll voice quality requires a no more than 50 millisecond end to end delay which imposes the 3 hop limit on pure wireless mesh architectures. The 3 hop restriction imposes a practical limit of no more than 8 nodes per mesh cluster. This is an inhibitor to using pure wireless mesh for city wide deployments where VOIP is a critical application (FIG. 2).

All known access solutions use a single technology, while this invention makes use of a hybrid of two or more technologies. This invention specifically focuses on a hybrid access network that connects wireless CPE users to the core IP network. The hybrid approach optimizes delivery of data and voice traffic, and supports high network availability by having redundancy and automatic failover. In contrast to the pure wireless mesh networks, the hybrid wireless mesh architecture terminates the wireless traffic with no more than 2 hops, and uses a fast low latency BPL backbone of 1-3 millisecond latency (FIG. 4).

### SUMMARY OF THE INVENTION

In one aspect, the present invention provides a hybrid access network comprising of two or more communication technologies, namely wireless and powerline communications, for delivery of broadband data, voice and video services over IP Specifically, the invention provides a hybrid access network using a hybrid architecture that encompasses a wireless distribution system integrated with a BPL backhaul to deliver the aggregated traffic of all wireless drops to and from a backhaul point (FIG. 3). The BPL backhaul comprises of a plurality of BPL nodes, each BPL node comprising two BPL modems and four wireless radios. Each BPL node acts as a repeater of the BPL signal. The wireless distribution system comprises of a plurality of wireless mesh network nodes, each wireless mesh network node comprising at least three wireless radios. Each wireless mesh network node acts as a wireless repeater. The backhaul point is usually the connection point to the internet or a private wide area network that is connected to the public internet. The hybrid solution can be used for last mile access applications over various distribution systems.

In a preferred embodiment, the present invention supports multiple backhaul points with wireless extensions, built in redundancy of the backhaul delivery system with wireless and BPL, and redundant backhaul points (FIG. 2).

In another aspect, the present invention provides a method of connecting wireless mesh network nodes and BPL nodes, the method comprising the steps of (a) providing two BPL modems and four wireless radios in each of said BPL nodes, one wireless radio for client service and the other wireless radios for traffic backhaul and redundancy, where each BPL node acts as a repeater of BPL signal; (b) providing at least three wireless radios in each of said wireless mesh network nodes, where each wireless mesh network node acts as a wireless repeater; (c) providing a wireless distribution system protocol for peer to peer communication among said plurality of BPL nodes and plurality of wireless mesh network nodes; and (d) selecting different frequencies for different wireless radios of BPL nodes and wireless mesh network nodes, thereby allowing full duplex operation to transmit and receive concurrently at any of said plurality of BPL nodes or at any of said plurality of wireless mesh network nodes.

In a preferred embodiment, the method of the invention provides for FDM signal multiplexing over BPL line to enable a high throughput data transfer of the aggregated traffic to and from backhaul point.

An object of the invention is to provide a hybrid last mile access network architecture for reduced latency and jitter in providing data, voice and video services over wireless to end consumers.

Further objects, features and advantages will become apparent from the following description, claims and drawings.

### BRIEF DESCRIPTION OF THE DRAWINGS

The above aspects of the invention are described in detail with reference to the attached drawings, where:

FIG. 1 shows the Global network architecture showing the network layers i.e. core network, hybrid access network and the subscriber network.

FIG. 2 shows how a hybrid access network system can be used to cover a city wide deployment.

FIG. 3 shows the wireless distribution system for covering one square mile.

FIG. 4 shows the latency in the hybrid access network using a VoW application.

### DETAILED DESCRIPTION OF THE INVENTION

### Definitions

Broadband over Power Lines (BPL) refers to the use of medium voltage power transmission lines for broadband communications. This invention uses a hybrid of two or more technologies i.e. wireless and power line communications, for delivery of broadband data, voice and video services over Internet Protocol (IP).

Backhaul refers to the transmission of data from a remote site; in this case, from the subscriber's CPE; to a central site; in this case, to the core network. A backhaul point is the ingress point of the hybrid BPUWireless network connecting to the core network.

Customer premises equipment (CPE) refers to equipment, placed at the subscriber end of the operation i.e. on the subscriber premises. The equipment can be owned either by the service provider or by the subscriber. Examples of CPEs are telephone handsets, broadband routers, cable set top boxes etc.

### Description

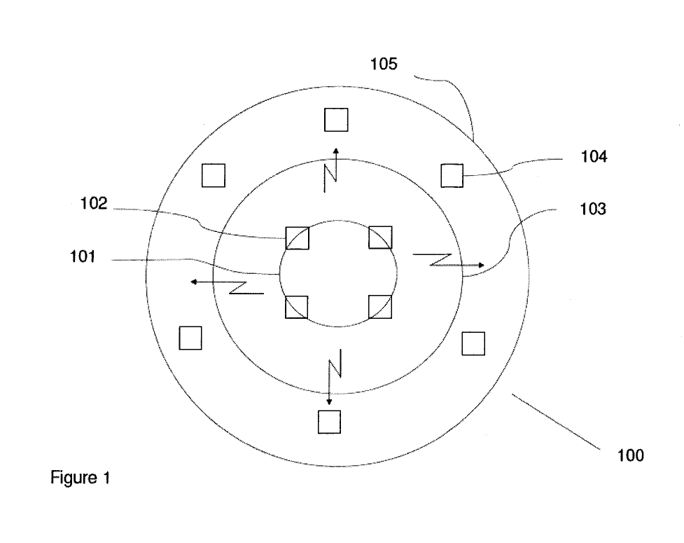

FIG. 1 shows a global network architecture diagram. There are three network layers, as shown in the figure; core network (101), a hybrid access network (103), a wireless subscriber network (105). A core network refers to a backbone network that provides connections between all the devices on the network. The internet can be considered as a system of core networks run by various hosts, which are interconnected with each other. An access network connects the subscriber to the service provider. In other words, it is the route from the subscriber to the service provider and could be a wireless network, Digital Subscriber Line (DSL), cable etc. Subscriber network refers to the media used by the subscriber to access the internet. The media used could be a phone line, cable etc. The edge routers (102) are located at the backhaul points; between the core network/fiber and the access network (hybrid). Customer Premises Equipment (CPE) (104) is used by the subscriber to access the internet. Subscribers use CPEs to connect to the network via wireless access. The aggregated wireless traffic from multiple subscribers is backhauled to the edge router by the access network.

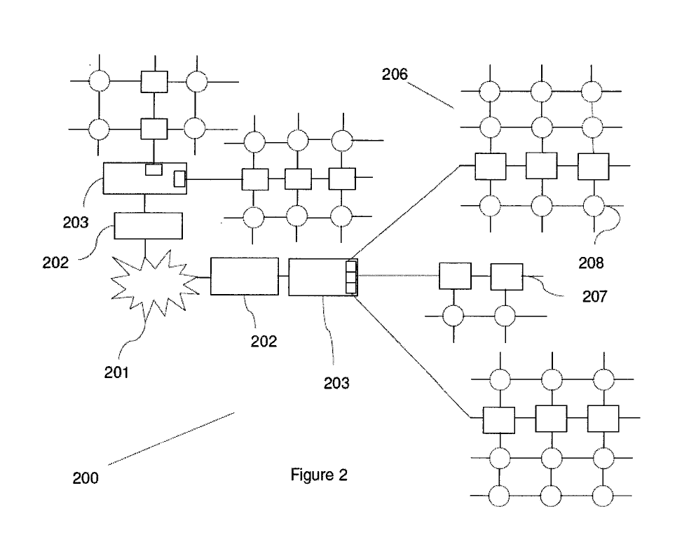

FIG. 2 shows how a hybrid system can be used for a citywide deployment. The figure shows a ground station (GS) (203) located at backhaul points; that can monitor multiple network segments (206) and the edge router (102), which then connects to the core i.e. the public internet (101). The GS is a platform that combines a number of server functions for monitoring and managing the network. It can be located anywhere on the network. The location of the GS as shown in FIG. 2 is one of the many possible positions of the GS and the architecture does not limit the position of the GS. An entire city can be covered by multiple hybrid access networks connected to a single or multiple backhaul points. The core network (101) is connected to multiple numbers of edge routers (102), each of which is further connected to ground stations (GS) (203). Each GS manages a number of network segments or subnets (206). Each hybrid access network subnet consists of a number of interconnected BPL nodes (207) and wireless repeaters (208) forming a mesh network.

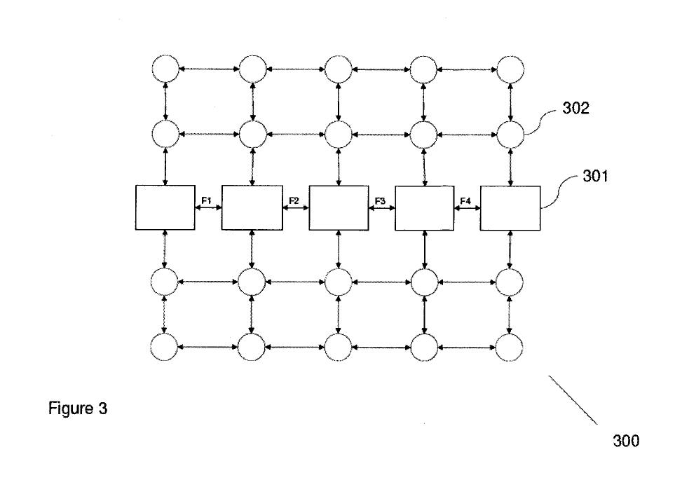

FIG. 3 shows how to cover a one square mile area with a hybrid mesh network. The architecture system uses two types of devices; BPL nodes (207) and wireless repeaters (208) to cover the area. The backbone of the system is a series of BPL nodes (called as Griffin (208)); each Griffin unit comprises of two BPL modems, four wireless radios and each Griffin unit acts as a repeater of the BPL signal. One radio contained in the Griffin is used for radio services and the other three radios are used for traffic backhaul and redundancy. The Griffin delivers the aggregated traffic to and from the backhaul point. The use of multiple radios in a mesh network also provides multiple paths through the network, eliminating the number of forwarding loops and hence reducing the number of hops to the backhaul network. Also, using Frequency Division Multiplexing (FDM) over the BPL links enables a high throughput data transfer of the aggregated traffic to and from the backhaul points. In FDM, multiple frequency channels from different Griffins are combined onto a single aggregate signal for transmission to the backhaul point. FDM is accomplished by setting the radios in each Griffin to a different non-interfering frequency channel. Different signals from various Griffins with different frequencies are combined over a single line. Also, a Griffin can send packets on two channels simultaneously using different radios, operating at different frequencies. As a result, a large number of Griffins are able to transfer data simultaneously. This results in an increase in the throughput data transfer between the Griffins and the backhaul points.

The wireless routers also called as Eagles connect to the Griffin to extend the coverage area. These Eagle units are connected to other Eagle units through wireless connectivity like WiFi and can be mounted on streetlights or the light poles. Each Eagle node contains three or four wireless radios and acts as a wireless repeater. Generally, in an Eagle unit, two of the radios handle the transmission and receiving of data traffic; while the third radio provides connectivity for the user. The use of multiple radios in the Eagle and the Griffin units, configured with different frequency channels enable full duplex operation, i.e. the units can transmit and receive concurrently. Wireless Distribution System (WDS) protocol is used for peer to peer communication among the Griffin units and the Eagle units. WDS is used to connect access points wirelessly in order to build a network which allows users of mobile equipment to roam and stay connected to the available network resources. WDS also permits a wireless network to be expanded using multiple access points.

The radios in each node (in a Griffin or an Eagle) need not belong to the same band, radios operating on different frequency bands can also be utilized within the same node. So, a mix of different radio types supporting multiple wireless technologies such as WiFi (a/b/g), MIMO, WiMAX, 900 MHz and 4.9 GHz radios can be used, making this hybrid architecture flexible. Each Eagle or Griffin covers a cell area of a given radius and each device also connects to its neighboring nodes as shown in FIG. 3.

In Voice over Internet Protocol (VoIP), voice conversations are digitized and packet based Internet Protocol (IP) networks carry the data. When using wireless networks for carrying VoIP packets, the overall voice quality is affected due to the delays resulting from packet processing time within the wireless node; also known as latency as the packet passes through a number of wireless nodes. Latency refers to the delay created in the conversation due to the internal processing time of each wireless node (approximately 10 to 30 milliseconds per node). The variation in delay of packet delivery is called jitter. In case of excessive traffic, the network drops packets. When a subscriber wants to transmit a packet, the CPE senses the channel to see if it is busy. If busy, the CPE waits a random amount of time before attempting again. These random wait periods adversely affect the performance of time-sensitive applications, such as VoIP. Since high priority information such as voice communications (VoIP) is not distinguished from regular data traffic, this time sensitive information has to contend for the channel in the same manner as regular data traffic, adding undesirable delays. In this hybrid architecture system, critical VoIP traffic is being distinguished from regular data by using Quality of Service (QoS). The VoIP packets are being marked at the ingress point of the network and classified by each node. The classification prioritizes the VoIP packets by putting them in different queues where they get serviced faster. The marking is then removed at the egress point of the network. Using QoS guarantees a high quality voice service even in the presence of high volume data traffic.

In the case of pure wireless networks, as the number of wireless hops increase for one call, the calls suffer from latency and the voice quality is significantly reduced due to echo and accumulated jitter. As the spectrum gets crowded these effects are greater than before. The use of multiple radios in Eagle and Griffin units also provides multiple paths through the network, eliminating the number of forwarding loops and hence reducing the number of hops to the backhaul network. This reduction in the number of hops reduces the latency of the network. The use of multiple radios and eagle units ensures a high throughput over the multiple hops. The VoIP packets need not contend with other radios or backhaul links. The time taken to process each packet inside a wireless repeater is considerably reduced. Single radio wireless repeaters usually have a latency of 30 to 50 milliseconds per hop, and dual radio repeaters have a latency of 10 to 30 milliseconds per hop. In comparison, a quad radio system with a BPL backbone for aggregated wireless traffic has a latency of 1 to 3 milliseconds.

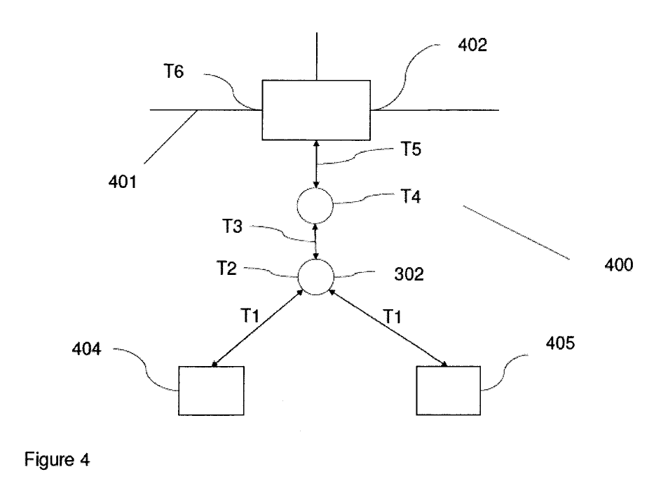

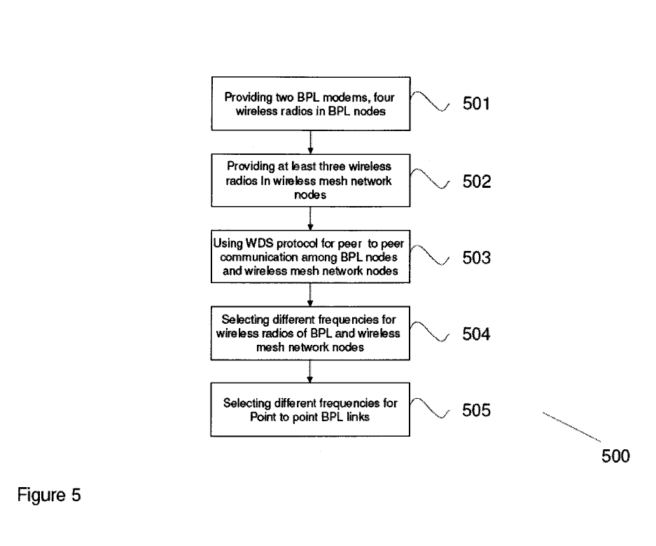

Referring to FIG. 4, it shows the BPL backbone with wireless drops in a VoIP application. The delay associated with the flow of packets from/to the user till the BPL backbone is calculated. The user can use a WiFi phone (405) or a WiFi VoIP Phone (404). The time T1 denotes time taken to transmit/receive VoIP packet between the user and the wireless access point (wireless repeater—302). The time T2 and T4 denote the delay in processing the packet inside a wireless repeater (302) while T3 and T5 represent the time required to transfer VoIP packets between the Wireless repeater units(302) using the wireless distribution network(300). The time T6 refers to the processing time of the packet inside the wireless access point of the BPL. The hybrid mesh network terminates the wireless traffic with no more than two hops. The Griffin unit also uses a fast low latency BPL backbone of 1-3 milliseconds.

FIG. 5 refers to a method of connecting wireless mesh network nodes and BPL nodes to form a hybrid access network, the method comprising the steps of (a) providing two BPL modems and four wireless radios in each of said BPL nodes, one wireless radio for client service and the other wireless radios for traffic backhaul and redundancy, where each BPL node acts as a repeater of BPL signal (501); (b) providing at least three wireless radios in each of said wireless mesh network nodes, where each wireless mesh network node acts as a wireless repeater (502); (c) providing a wireless distribution system protocol for peer to peer communication among said plurality of BPL nodes and plurality of wireless mesh network nodes (503); (d) selecting different frequencies for different wireless radios of BPL nodes and wireless mesh network nodes, thereby allowing full duplex operation to transmit and receive concurrently at any of said plurality of BPL nodes or at any of said plurality of wireless mesh network nodes (504); and (e) selecting different frequencies for point to point BPL links to enable full duplex high throughput data transfer over the powerline (505).

Although the present invention has been described with particular reference to specific examples, variations and modifications of the present invention can be effected within the spirit and scope of the following claims.

1-14. (canceled)

15. A hybrid access network, comprising:
a cluster comprising a plurality of Hybrid BPL/Wireless nodes (Griffin nodes), each Griffin node comprising at least two BPL modems and at least three wireless radios, where each Griffin node acts as a repeater of BPL signal, and where said plurality of Griffin nodes are connected to a backhaul aggregation point; and
a wireless distribution system comprising a plurality of wireless mesh network nodes (Eagle nodes), each Eagle node comprising at least three wireless radios, and each Eagle node acting as a wireless repeater,
where said hybrid network is using a combination of said Eagle nodes and said Griffin nodes, and where said network is configured to limit wireless traffic to a maximum of two hops, and, where said hybrid mesh network of Griffin nodes and Eagle nodes provide a system with low latency, high availability, and high throughput for broadband data, voice and video services, and for control applications requiring real time response.

16. A hybrid access network as in claim 15, where said Griffin nodes and said Eagle nodes use Wireless Distribution System (WDS) protocol for peer to peer communication.

17. A hybrid access network as in claim 15, where in said Griffin nodes, said plurality of wireless radios are configured with different frequency channels to enable a full duplex operation to transmit and receive concurrently.

18. A hybrid access network as in claim 15, where in said Eagle nodes, said plurality of wireless radios are configured with different frequency channels to enable a full duplex operation to transmit and receive concurrently.

19. A hybrid access network as in claim 15, where said wireless radios are WiFi(a) wireless radios.

20. A hybrid access network as in claim 15, where said wireless radios are WiFi (b) wireless radios.

21. A hybrid access network as in claim 15, where said wireless radios are WiFi (g) wireless radios.

22. A hybrid access network as in claim 15, where said wireless radios are MIMO wireless radios.

23. A hybrid access network as in claim 15, where said wireless radios are WiMAX wireless radios.

24. A hybrid access network as in claim 15, where said wireless radios are 900 MHz wireless radios.

25. A hybrid access network as in claim 15, where said wireless radios are 4.9 GHz wireless radios.

26. A hybrid access network as in claim 15, where said wireless radios are selected in any combination from a group of wireless radios including WiFi(a), WiFi(b), WiFi(g), MIMO, WiMAX, 900 MHz, and 4.9 GHz wireless radios.

27. A hybrid access network as in claim 15, where a control application is protective relaying.

28. A hybrid access network as in claim 15, where said network is a standards based IP network.

29. A hybrid access network as in claim 15, where said network is configured to sense discontinuities in communication flow and switch between wireless and BPL communication in a seamless manner.

30. A hybrid access network as in claim 15, where said BPL network operates over Medium Voltage and High Voltage power lines.

31. In a hybrid access network having a plurality of wireless mesh network nodes (Eagle nodes) and Hybrid BPL/Wireless nodes (Griffin nodes), a method of connecting said Eagle nodes and Griffin nodes to provide a system with low latency, high availability, and high throughput, the method comprising the steps of:
providing at least two BPL modems and at least four wireless radios in each of said Griffin nodes, at least one of said at least three wireless radios, one wireless radio for providing radio services to user devices and remaining wireless radios for traffic backhaul and redundancy, where each Griffin node acts as a repeater of BPL signal;
providing at least three wireless radios in each of said Eagle nodes, at least two of said at least three wireless radios being used for transmission and receiving operations and remaining wireless radios being used for connectivity to user devices, and where each said Eagle node acts as a wireless repeater;
providing a wireless distribution system for peer to peer communication among said plurality of Griffin nodes and said plurality of Eagle nodes;
selecting different frequencies for different wireless radios of said Griffin nodes and said Eagle nodes, thereby allowing full duplex operation to transmit and receive concurrently at any of said plurality of Griffin nodes or at any of said plurality of Eagle nodes;
selecting different frequencies for point to point BPL links to enable full duplex high throughput data transfer over powerline; and
limiting wireless traffic to two a maximum of two hops to control latency in the network.

32. A method as in claim 31, where the method provides for FDM signal multiplexing for communication over BPL, thereby enabling a high throughput data transfer of the aggregated traffic to and from backhaul point.
